(19) United States
(12) Patent Application Publication
(10) Pub. No.: US 2006/0245159 A1
(43) Pub. Date: Nov. 2, 2006

(54) COVER MECHANISM FOR DATA STORAGE DEVICE

(76) Inventors: Yang-Ming Lin, Shenzhen (CN); Xiao-Zhong Jing, Shenzhen (CN); Ding-Fang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,963

(22) Filed: Jan. 17, 2006

(30) Foreign Application Priority Data
Apr. 28, 2005 (CN) 200520057885.5

(51) Int. Cl. G06F 1/16

(52) U.S. Cl. 361/685

(57) ABSTRACT

A cover mechanism for protecting a storage device from contamination and included a bezel (1), a cover (2), a pair of resilient members (3), and a pair of relay members (4). The bezel includes an opening (12) defined therein for the storage device passing therethrough, a pair of passages (15) defined therein and besides the opening, and a pair of tabs (14) extending therefrom. Each tab includes a groove (142) therein. The cover includes a pair of flanges (24). Each flange includes a pivoting hole (244) defined therein, and a post (242) extending therefrom. The posts move along the grooves of the bezel. The relay members slidably receive in the passages and each include a shaft (41) pivotally engaging in the pivoting hole of the cover. Two ends of each of the resilient members are separately fixed to the cover and the bezel.

### CROSS-REFERENCES TO RELATED APPLICATION

Related subject matter is disclosed in two co-pending U.S. patent applications with same title and assigned to the same assignee with this application.

### FIELD OF THE INVENTION

The present invention relates to cover mechanisms, and particularly to a cover mechanism which can protect a data storage device from contamination and humidity.

### DESCRIPTION OF RELATED ART

Data storage devices, such as optical disk drives, are installed in a computer enclosure for communication and processing data. An optical disk drive includes a case and a tray received in the case. The tray can accommodate an optical disk therein. A front bezel is positioned in front of the computer enclosure. An opening is defined in the front bezel. The tray can be moved into or out of the enclosure through the opening of the front bezel.

For example, a typical personal computer includes an enclosure for protection of internal devices, such as hard disk drives, compact disk read-only memory (CD-ROM) drives, a motherboard, and the like. To access the CD-ROM drive, an opening is defined in the enclosure. However, contamination and humidity often harm the personal computer via the opening.

To address aforementioned problem, an enclosure having a protective cover as described in China Patent No. 98220678.X is invented. The enclosure includes a front panel defining an opening, and a cover is pivotably attached to the front panel via pivots for shielding the opening. However, the cover includes a protruding part which always extends out of a front bezel no matter the cover is open or closed so that the cover is prone to be damaged in transportation or in use due to any accidental impact. This contingency usually leads to a short life and an unpleasant appearance of the cover.

What is desired, therefore, is a cover mechanism protecting a data storage device from any accidental damage.

### SUMMARY OF INVENTION

In one preferred embodiment, a cover mechanism for protecting a storage device from contamination and included a bezel, a cover, a pair of resilient members, and a pair of relay members. The bezel includes an opening defined therein for the storage device passing therethrough, a pair of passages defined therein and besides the opening, and a pair of tabs extending therefrom. Each tab includes a groove therein. The cover includes a pair of flanges. Each flange includes a pivoting hole defined therein, and a post extending therefrom. The posts move along the grooves of the bezel. The relay members slidably receive in the passages and each include a shaft pivotally engaging in the pivoting hole of the cover. Two ends of each of the resilient members are separately fixed to the cover and the bezel.

Other advantages and novel features will become more apparent from the following detailed description of preferred embodiments when taken in conjunction with the accompanying drawings, in which:

### BRIEF DESCRIPTION OF DRAWINGS

FIGS. 1 and 2 are exploded, isometric views of a cover mechanism in accordance with a preferred embodiment of the present invention, but viewed from different aspects; and

FIGS. 3 and 4 are assembled views of FIG. 2, respectively schematically showing the cover mechanism in different working states.

### DETAILED DESCRIPTION

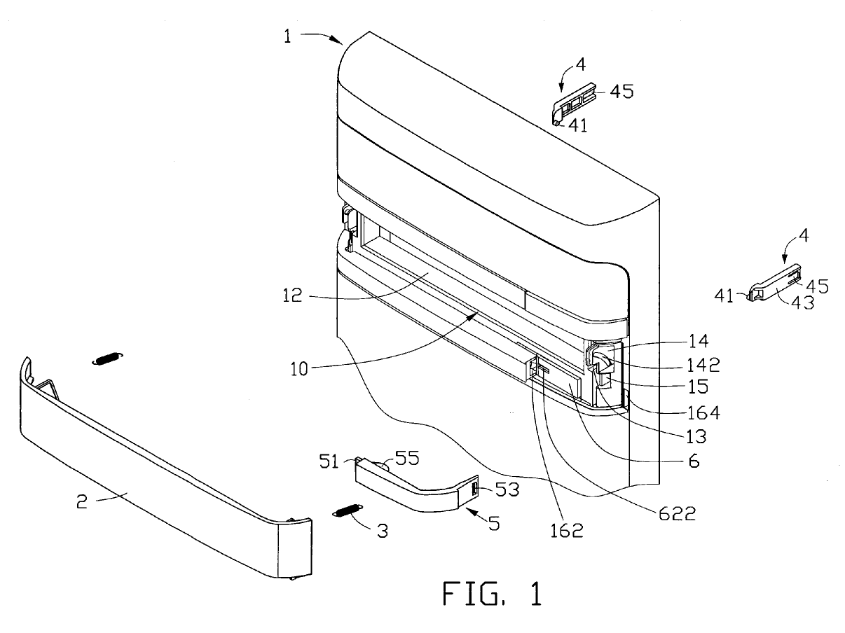

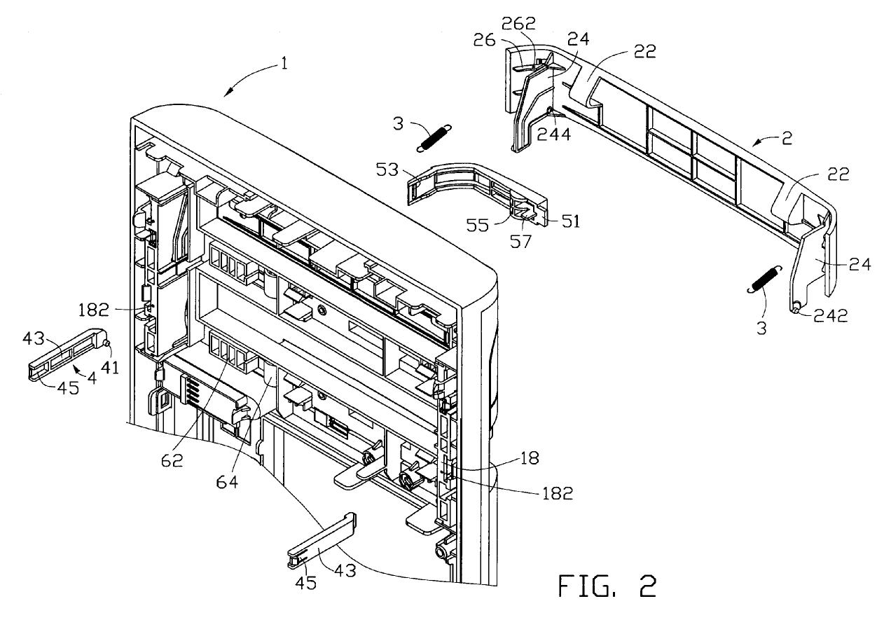

Referring to FIGS. 1 and 2, a cover mechanism of an electronic appliance in accordance with the preferred embodiment of the present invention is provided for protecting storage devices from accidental damage. The cover mechanism includes a bezel 1, a cover 2 attached to the bezel 1, a pair of resilient members 3 disposed between the cover 2 and the bezel 1, and a pair of relay members 4 movably connecting the cover 2 to the bezel 1. A button 5 is attached to the bezel 1 to actuate the storage devices.

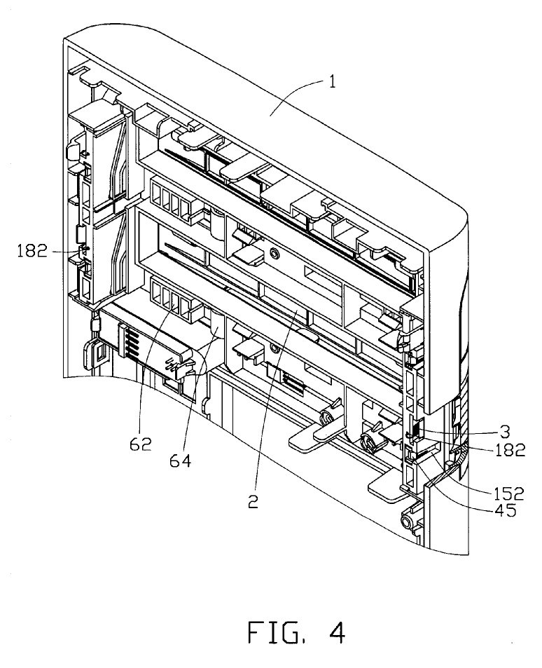

The bezel 1 has a curved configuration and defines an inverted L-shaped recess 10 therein. The cover 2 and the button 5 have corresponding configurations and receive in the recess 10, integrating with the bezel 1 as a whole. The bezel 1 defines an opening 12 in the recess 10 thereof. The opening 12 is provided an entrance for a storage device (not shown) moving therethrough. A pair of notches 13 is defined in the bezel 1, besides the opening 12. A tab 14 extends from the bezel 1 and separates each of the notches 13 into two portions. An arc-shaped groove 142 is defined in each of the tabs 14. A pair of passages 15 is defined in the bezel 1, below the tabs 14. Referring also to FIG. 4, a channel 152 is defined in an outer sidewall of each passage 15. A trigger member 6 is formed from an inner side of the bezel 1, below a right portion of the opening 12. The trigger member 6 includes a touch portion 62, and resilient portion 64. A fixing slit 622 is defined in the touch portion 62. A pair of fixing slots 162, 164 is defined in the bezel 1, corresponding to the trigger member 6. A pair of first fixing apertures 182 is defined in ledges 18 extending from the inner side of the bezel 1.

The cover 2 includes a pair of triangular protrusions 22 extending from an inner side thereof. A pair of flanges 24 vertically extends from the inner side of the cover 2. A pair of boards 26 horizontally extends from the inner sides of the cover 2 besides the flanges 24. Each of the flanges 24 includes a post 242 extending from an outer portion thereof, and a pivoting hole 244 defined in an inner portion thereof. A second fixing aperture 262 is defined in each of the boards 26.

Each relay member 4 includes a body 43, a shaft 41, and a catch 45. The bodies 43 are slidably received in the passages 15 of the bezel 1. Each of the shafts 41 is formed at one end of the corresponding relay member 4 and pivotally received in the corresponding pivoting hole 244 of the cover 2. Each of the catches 45 is formed at another end of each relay member 4 and slidably engaging in the corresponding channel 152 of the passages 15 of the bezel 1.

The resilient members 2 are received in notches 13 of the bezel 1. Each resilient member 2 is a coil spring, with its two ends separately fixed in the first apertures 182 of the bezel 1 and the second apertures 262 of the boards 26 of the cover 2.

The button 5 includes a fixing tab 51, and a hook 53 disposed at opposite ends thereof. A protrusion 55 extends from the button 5 near the fixing tab 51. A tip 57 extends from the button 5 between the block 51 and the protrusion 55.

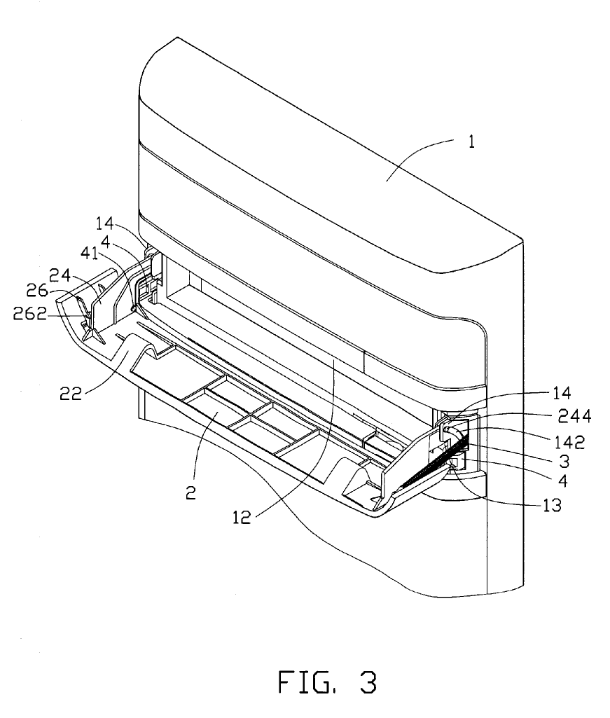

Referring also to FIGS. 3 and 4, in assembly, the relay members 4 are assembled to the cover 2 and bezel 1. The relay members 4 are slidably received in the passages 15 of the bezel 1, with the catches 45 engaging in the channels 152 and the shafts 242 pivotally engaging in the pivoting holes 244 of the cover 2. The flanges 24 of the cover 2 are received in inner portions of the notches 13 of the bezel 1. The posts 242 pivotally engage in the grooves 142 of the bezel 1. The resilient members 3 are received in outer portions of the notches 13. Two ends of each of the resilient members 2 are separately fixed in the first fixing aperture 182 of the bezel 1 and the second fixing aperture 262 of the cover 2. The button 5 is attached to the bezel 1. The block 51 and the hook 53 of the button 5 separately engage in the fixing slots 162, 164 of the bezel 1. The tip 57 of the button 5 engages in the fixing slit 622 of the trigger member 6. The protrusion 55 of the button 5 abuts the touch portion 62 of the trigger member 6.

To open the cover 2, the button 5 is pushed toward the bezel 1. The protrusion 55 of the button 5 abuts against the touch portion 62 of the trigger member 6 to actuate the storage device. The resilient portion 64 of the button 6 is deformed. The storage device is moved out from the opening 12 of the bezel 1 and gradually urges the protrusions 22 to propel the cover 2 outwardly. The resilient members 3 are stretched. The bodies 43 of the relay members 4 are moved outwardly in the passages 15 of the bezel 1. The relay members 4 slide in the passage 15 of the bezel 1 and rotate about the shafts 41 thereof. The catches 45 of the relay members 4 engage in the channel 142 of the bezel 1. At the same time, the cover 1 is rotated outwardly about the posts 242 thereof. The posts 242 of the cover 2 move along the grooves 142 of the bezel 1. Thus the cover 1 is gradually opened and the storage device can be operated. The resilient member 3 rebound when the button 5 is released. The button 5 accordingly moves back to its original position. The resilient member 3 rebound and the cover 2 covers the bezel 1 again. The shafts 41 of the relay members 4 rotate in the pivoting holes 244 of the cover 2.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A cover mechanism for protecting a storage devices installed in an electronic device, the cover mechanism comprising:
a bezel defining an opening for the storage device passing therethrough, a pair of passages defined besides the opening, and a pair of tabs each defining a groove therein;
a cover covering the opening of the bezel and comprising a pair of flanges, each of the flanges comprising a post, and a pivoting hole, the posts sliding in the grooves;
a pair of relay members sliding in the passages of the bezel, each of the relay members comprising a shaft pivotally received in the pivoting holes of the cover; and
a resilient member disposed between the cover and the bezel.

2. The cover mechanism as claimed in claim 1, wherein each of the relay members further comprises a catch formed at an end thereof, each of the passages further comprises a channel defined in a sidewall thereof to engage with the catch.

3. The cover mechanism as claimed in claim 2, wherein a pair of notches is defined in the bezel besides the opening, the tabs separate the notches into two portions, each of the flanges is received in one portion of the corresponding notch.

4. The cover mechanism as claimed in claim 4, wherein the bezel defines a pair of first fixing aperture therein, the cover comprises a pair of boards each defining a second fixing aperture, the resilient member is a pair of coil springs and each received in the other portion of the corresponding notch.

5. The cover mechanism as claimed in claim 1, wherein the cover comprises a pair of protrusions movably received in the opening of the bezel, the protrusions have triangular configurations.

6. The cover mechanism as claimed in claim 1, wherein the bezel further comprises a trigger member disposed below the opening, and a button attached thereto to engage the trigger member.

7. The cover mechanism as claimed in claim 6, wherein the button comprises a protrusion, the trigger member comprises a touch portion engagingly abutted against by the protrusion.

8. The cover mechanism as claimed in claim 7, wherein the button comprises a locking tab, a hook disposed at two ends thereof, the bezel comprises a pair of locking slots engaging with the locking tab and the hook.

9. The cover mechanism as claimed in claim 6, wherein the bezel defines a recess therein for receiving the cover and the button therein and integrate with the bezel as a whole.

10. The cover mechanism as claimed in claim 9, wherein the bezel has a curved configuration.

11. A cover mechanism for protecting a storage devices installed in an electronic device, the cover mechanism comprising:
a bezel defining an opening therein;
a cover movably covering the opening of the bezel and comprising a post rotatably engaging with the bezel; and
a pair of relay members slidably received in the bezel, said relay member pivotally engaging with the cover at one end thereof.

12. The cover mechanism as claimed in claim 11, further comprises a resilient member disposed between the cover and the bezel.

13. The cover mechanism as claimed in claim 11, wherein the bezel defines a pair of first fixing aperture therein, the cover comprises a pair of boards each defining a second fixing aperture, the resilient member is a pair of coil springs, two ends of the each of the coil springs are fixed to the first and second apertures.

14. The cover mechanism as claimed in claim 11, wherein the cover comprises a pair of flanges, each of the flanges comprises a post extending therefrom, the bezel comprises a pair of tabs disposed besides the opening, each of the tabs defines a groove therein, the posts slide in the grooves.

15. The cover mechanism as claimed in claim 14, wherein the flanges each comprise a pivoting hole therein, each of the relay members comprises a shaft disposed at one end thereof, the shafts are pivotally received in the pivoting holes.

16. The cover mechanism as claimed in claim 11, wherein the bezel defines a pair of passages for receiving the relay members therein.

17. The cover mechanism as claimed in claim 16, wherein each of the relay members further comprises a catch formed at an end thereof, each of the passages further comprises a channel defined in a sidewall thereof to engage with the catch.

18. The cover mechanism as claimed in claim 11, wherein the bezel further comprises a trigger member disposed below the opening, and a button attached thereto to engage the trigger member.
